(19) United States
(12) Patent Application Publication
(10) Pub. No.: US 2024/0342714 A1
(43) Pub. Date: Oct. 17, 2024

(54) MICROFLUIDIC ELEMENT, IN PARTICULAR A FLOW CELL, COMPRISING AN INTEGRATED DRY REAGENT

(71) Applicant: THINXXS MICROTECHNOLOGY GMBH, Zweibrücken (DE)

(72) Inventor: Lutz WEBER, Münchweiler (DE)

(21) Appl. No.: 18/701,052

(22) PCT Filed: Oct. 10, 2022
(86) PCT No.: PCT/EP2022/078034

§ 371 Date: Apr. 15, 2024

(30) Foreign Application Priority Data
Oct. 28, 2021 (EP) 21205300.3

(51) Int. Cl. B01L 3/00

(52) U.S. Cl. CPC B01L 3/50273; B01L 3/502707; B01L 2300/044; B01L 2300/048; B01L 2300/0809; B01L 2300/0838; B01L 2300/0861; B01L 2300/0883; B01L 2300/14; B01L 2400/0487; B01L 2400/084

(57) ABSTRACT

A microfluidic element, in particular a flow cell, for processing a quantity of liquid which is to be transported in a channel region of the microfluidic element and which comes into contact with a dry reagent integrated in the microfluidic element. The dry reagent is located in an outwardly open end portion of the channel region. A method for manufacturing such a microfluidic element, a combination of the microelement and an operator device, and a method for operating the microelement using the operator device.

The invention relates to a microfluidic element, in particular a flow cell, for processing a quantity of liquid which is to be transported in a channel region of the microfluidic element and comes in contact with a dry reagent integrated into the microfluidic element.

The invention further relates to a method for producing such a microfluidic element, or a combination of such a microfluidic element with operating devices, and to a method for operating such a microfluidic element.

As is known, microfluidic elements, in particular flow cells, are being used increasingly for analysis and/or synthesis in the life sciences. In flow cells comprising cavity structures with channels and chambers, very small fluid volumes can be transported and processed, for example quantities of liquid less than 10 μl.

One particular problem in the production of microfluidic elements is the integration of dry reagents, which need to be made compatible with further manufacturing steps. In particular, subsequent welding and adhesive bonding processes may significantly damage dry reagents that have already been introduced.

EP 2 821 138 A1 discloses a method for manufacturing flow cells, in which dry reagents adhering on the end side to stopper-shaped carrier elements are introduced in a final manufacturing step into openings of the flow cell. By inserting the carrier element into an access opening to a transport channel of the flow cell, the opening is sealed and the dry reagent is placed adjacent to the transport channel. The handling of such sometimes very small carrier elements with diameters of, for example, 1 mm is very difficult. Problems occur in particular when many, for example more than ten, different dry reagents for different reactions are to be placed inside the flow cell.

The object of the invention is to provide a novel microfluidic element of the type mentioned in the introduction, the required production outlay of which is further reduced.

The microfluidic element according to the invention, which achieves this object, is characterized in that the dry reagent is arranged in an outwardly open end portion of the channel region.

Advantageously, by this solution according to the invention, a dry reagent may be introduced into the microfluidic element in a final manufacturing step without being damaged by manufacturing steps such as adhesive bonding or welding, the outwardly open end portion being accessible in order to receive a liquid reagent by pipetting or immersion, and the liquid being capable of drying rapidly near to the opening.

Although it is conceivable that the quantity of liquid, for example a sample liquid to be analyzed, is also introduced into the microfluidic element through the end portion that contains the dry reagent and in doing so redissolves the dry reagent adhering to the channel wall, in one particularly preferred embodiment of the invention the channel region has a further outwardly open end portion for introducing the quantity of liquid, which is in fluid communication with the end portion that contains the dry reagent. By an operating device, to which the microfluidic element can be coupled in a hermetically leaktight fashion, the quantity of fluid can be transferred by means of an applied pneumatic pressure into the end portion that has the dry reagent, where redissolving of the dry reagent takes place, for example by diffusion or moving the quantity of fluid to and fro.

The end portion that has the dry reagent and the further end portion for introducing the quantity of liquid are expediently each bounded by a constriction of the channel cross section. The constriction forms a barrier for liquid up to a limit pressure, but is permeable for air.

Preferably, the surfaces that come in contact with liquid of both or one of the end portions are hydrophilized and have a contact angle with water <60°, for example by a hydrophilic coating or by a surface treatment such as corona or plasma treatment or by plasma polymerization, or by a wet chemical treatment.

Preferably, the end portion and the further end portion are each configured as a capillary channel and, in particular, are hydrophilized.

In one embodiment, the end portion and/or the further end portion is formed in a projection that protrudes, in particular perpendicularly, from a substantially plate-shaped base body of the microfluidic element. Such a projection facilitates both the introduction of liquids into the end portions and the attachment of pneumatic transport pressure sources.

An end portion with a hydrophilic surface may take up by capillary action a quantity of liquid, for example a sample quantity, which has been introduced by dispensing or pipetting, and thus minimize the surface area of the sample quantity that is in contact with the environment while avoiding evaporation effects.

The projection or the projections are preferably formed integrally with a substrate that the base body comprises, so that the projections may be produced in one working step with the substrate in the case of injection-molding the substrate. Alternatively, the end portion with the dry reagent may be formed in a separate carrier element which at least partially forms the projection and is connected to the microfluidic element by adhesive bonding, welding and/or press fitting.

In a further embodiment, the end portion that has the dry reagent is externally covered by a breakable film or a gas-permeable but liquid-impermeable membrane. The breakable film advantageously protects the dry reagent from the effects of moisture during storage of the microfluidic element. The advantage of the gas-permeable membrane is that it bounds the channel region, which prevents unintended escape of liquid from the channel region.

The channel region may for example comprise a chamber, which for example forms a detection and/or reaction region, the microfluidic element expediently being transparent for optical measurements at least in the region of the chamber.

Operating devices, for example configured as a separate component, for the microfluidic element expediently comprise a controllable pneumatic pressure source for attachment to the further end portion that is intended to receive the quantity of liquid and a passive pressure source, comprising a closed compression space, for attachment to the end portion that has the dry reagent. Air enclosed in the closed space of the passive pressure source is compressed during the displacement of the quantity of liquid.

By controlling the pressure of the controllable pressure source to be greater than the pressure respectively built up in the closed compression space, the quantity of liquid is displaced toward the end portion with the dry reagent. By keeping the pressure of the controllable pressure source constant, the quantity of liquid inside the channel region may be placed at a location that depends on the pressure. This allows a to-and-fro movement of the quantity of liquid, which promotes redissolving and thorough mixing of the dry reagent with the quantity of liquid.

Expediently, the separate operating device and optionally the microfluidic element have valve devices for pressureless decoupling of the microfluidic element from the operating device, which ensures that the pressure of both pressure sources lies at ambient pressure in the event of decoupling.

Expediently, the operating devices comprise one or more sensors for recording the respective position of the quantity of liquid inside the channel region, for example a pressure sensor.

The aforementioned pneumatic pressure sources expediently have a cap-like attachment piece, which can be fitted over the projection that contains the end portion and bears on the microfluidic element in a gastight fashion, for example via an O-ring.

In a further embodiment of a flow cell according to the invention, a plurality of end portions that contain a dry reagent are formed by the channel region being branched into a plurality of channel parts, each of which contains an end portion with a dry reagent.

The invention is further explained below with the aid of exemplary embodiments and the appended drawings, which relate to these exemplary embodiments.

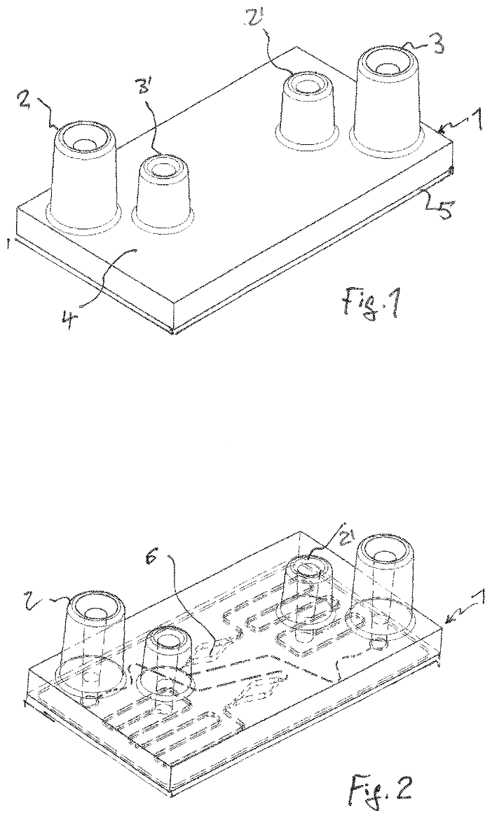

FIGS. 1 and 2 show a flow cell according to the invention with two function regions that can be operated independently of one another,

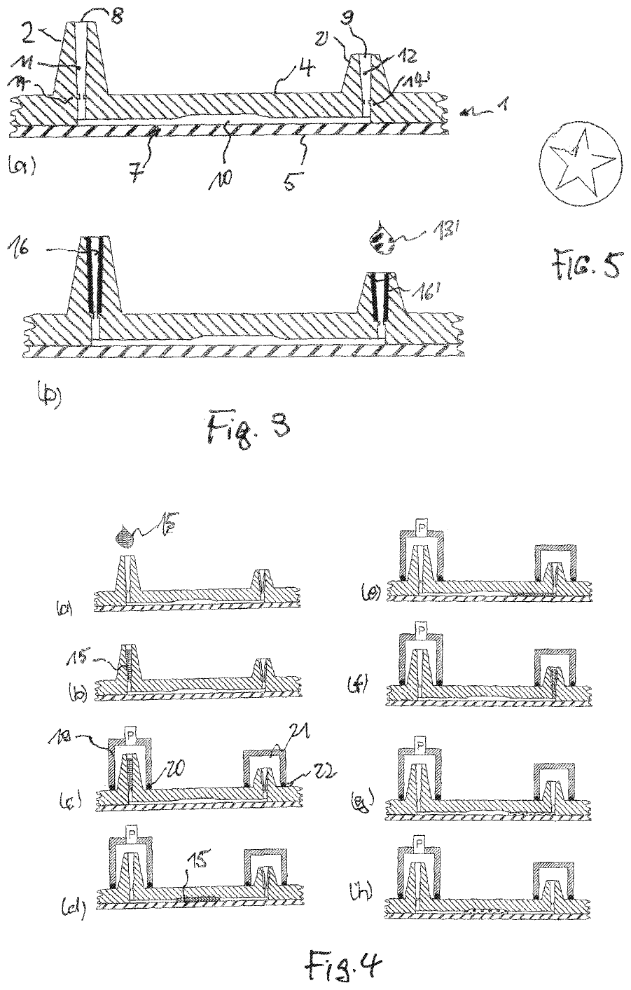

FIG. 3 shows sectional subregions of the flow cell of FIGS. 1 and 2,

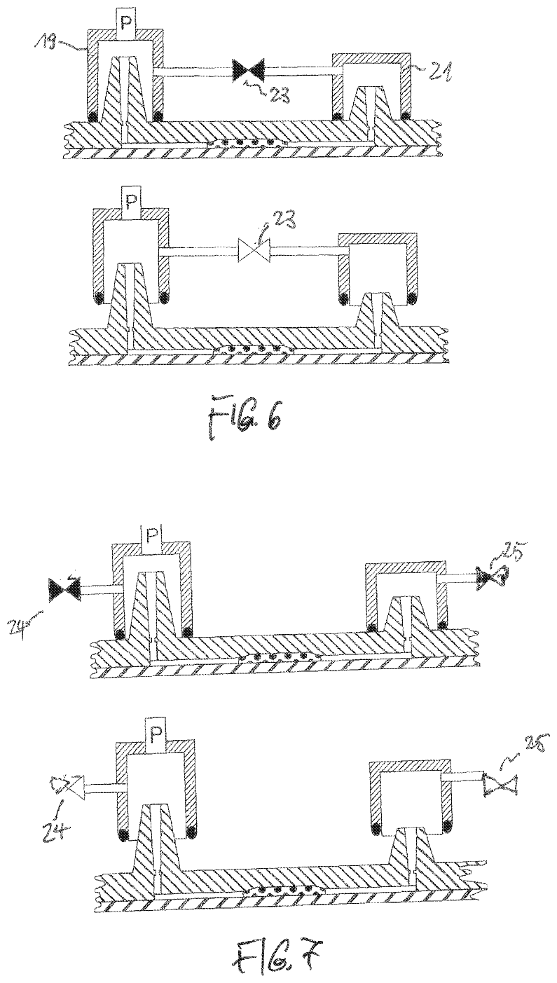

FIG. 4 shows a representation explaining the function of the flow cell of FIGS. 1 to 3,

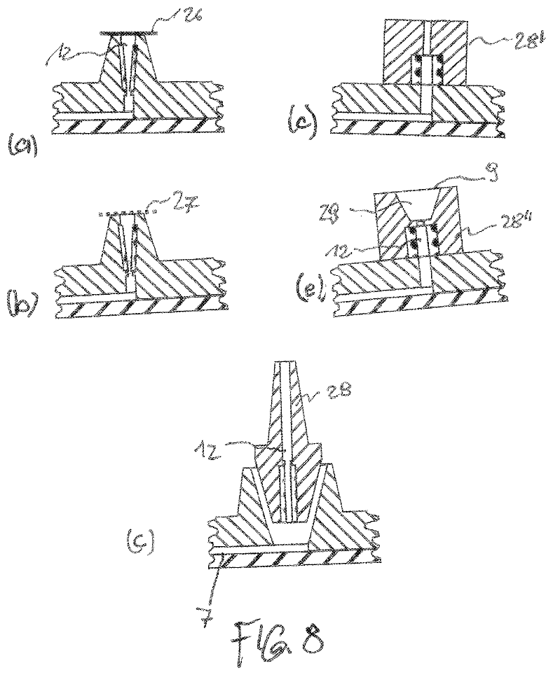

FIGS. 5 and 6 show representations explaining devices for pressureless decoupling of the flow cell of FIGS. 1 to 3 from an operating device,

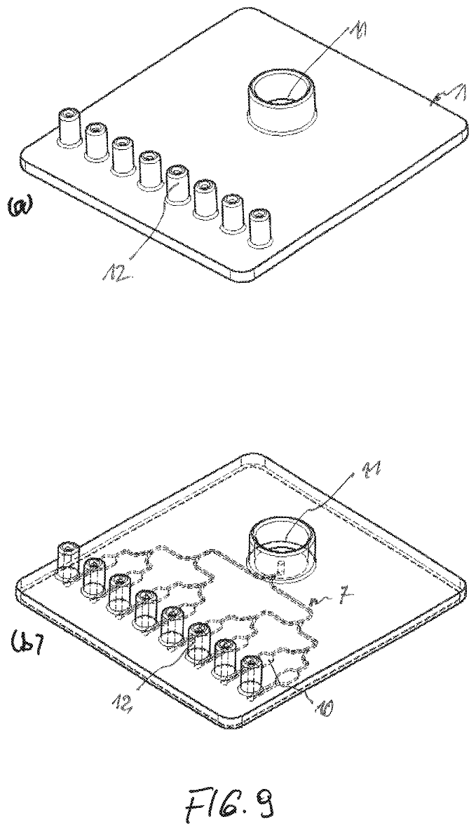

FIG. 7 shows various embodiments of an end portion, which contains a dry reagent, of a channel region of the flow cell of FIGS. 1 to 3, and

FIGS. 8 to 10 show further exemplary embodiments of flow cells according to the invention.

A microfluidic element as shown in FIGS. 1 and 2 comprises a plate-shaped base body 1, from which projections 2,2′ and 3,3′ protrude perpendicularly. The base body 1 has a substrate 4, to which the projections 2,2′ and 3,3′ are integrally connected. On its side facing away from the projections, the substrate 4 is adhesively bonded or welded to a film 5. The substrate 1 is injection-molded with the projections 2,2′ and 3,3′ and consists of a plastic, preferably COC, COP, PMMA, PC, PS, PE, PP or PEEK.

The film 5 seals recesses formed in the substrate, so that a cavity structure 6 (which can be seen in FIG. 2) is formed within the base body 1 for two flow cells that can be operated independently of one another.

FIG. 3 schematically shows a cross section through one of the flow cells with the projections 2 and 2′.

As may be seen in FIG. 3, the flow cell comprises a channel region 7 which extends from an opening 8 through the projection 2, the base body 1 and the projection 2′ as far as an opening 9. The channel region 7 comprises a chamber 10 which is arranged approximately in the middle of the channel region in relation to the channel length.

Both the projection 2 and the projection 2′ each form an end portion 11 and 12, respectively, of the channel region 7. As may furthermore be seen in FIG. 3, the end portions 11, 12 are each bounded by a channel constriction 14 and 14′, respectively. The two end portions 11, 12 each have, according to FIG. 3b, a hydrophilizing layer indicated at 16 and 16′. The hydrophilizing layers 16, 16′ are not represented in FIG. 3a or the subsequent FIG. 4.

FIG. 3b shows a drop of a reagent liquid 13′ which can be introduced into the end portion 12 of the channel region 7, for example with the aid of a pipette, this reagent liquid filling the end portion 12 as far as the constriction 14′.

In the course of drying of the reagent liquid 13′, a dry reagent 13 shown in FIG. 4 is deposited on the channel wall of the end portion 12.

According to FIG. 4, the flow cell of FIGS. 1 to 3 prefabricated with the dry reagent 13 is used as follows: for example with the aid of a pipette, a quantity of liquid sample 15 to be processed, for example analyzed, is introduced into the end portion 11 and fills the end portion 11, configured in the example as a capillary channel, as far as the channel constriction 14 that forms a capillary stop (FIG. 4b). The dry reagent 13 is dried on the wall of the end portion 12.

An operating device comprises a controllable pneumatic pressure source with a cap-like attachment piece 19, which can be fitted over the end portion 11 and can be pressed onto the flow cell in a gastight fashion via an O-ring 20.

A second attachment piece 21, which can be fitted over the end portion 12, bears in a gastight fashion against the flow cell via an O-ring 22 and forms a passive pressure source in the form of a closed compression space.

After the attachment pieces 19, 21 have been fitted onto the flow cell, atmospheric pressure initially prevails below the cap-like attachment pieces. By increasing the pressure of the controllable pressure source, the liquid sample quantity 15 can be displaced for example into the chamber 10 (FIG. 4d) and positioned there by the pressure of the controllable pressure source not being increased further and an equilibrium prevailing between the pressure of the controllable pressure source and the pressure of the passive pressure source.

According to FIG. 4e, the sample quantity 15 is displaced further beyond the chamber 10 by increasing the pressure of the controllable pressure source of the operating device, and according to FIG. 4f enters the end portion 12 of the channel region 7, where it comes into contact with the dry the reagent 13 and redissolves dry reagent. By correspondingly controlling the pressure of the controllable pressure source, the liquid sample quantity with the redissolved dry reagent can be displaced to and fro between the position shown in FIG. 4f and the position shown in FIG. 4g, the transport around the 90° bend of the channel region 7 near to the end portion 12 ensuring intensive mixing of the liquid 15 with the reagent.

In the position shown in FIG. 4h, the liquid sample quantity with the redissolved reagent is located in the chamber 10, and an optical examination of the liquid sample quantity can take place through the substrate 4 (which is transparent in the example) and/or the film 5. Optical measurements are also already possible in the position of the liquid sample quantity as shown in FIG. 4d. By such double measurements, effects that influence the optical signal, such as transparency or autofluorescence of the flow cell materials of the substrate and the film, which are arranged in the detection region, can be calculated out from the optical signal by taking the difference.

By reducing the pressure of the controllable pressure sources to atmospheric pressure, the sample liquid can be brought back out of the chamber 10 into its starting position and the flow cell can be decoupled pressurelessly from the operating device.

In order to prefabricate the flow cell with the dry reagent, a reagent liquid is introduced into the end portion 12 of the channel region 7, for example by means of a pipette, the constriction 14′ preventing the channel region 7 from being wetted beyond the end portion 12.

In a subsequent drying step at room temperature, thermal treatment or freeze-drying, the liquid component evaporates and dry reagent is deposited on the wall of the end portion 12. It is to be understood that the dried quantity of reagent does not block the channel region 7 and air can still emerge through the opening 9.

It is therefore helpful to configure the inner face of the end portion 12 for example with axial grooves or in a star-shape according to FIG. 5, the reagent preferably drying in the region of the grooves by capillary action and not in the center of the end portion 12.

FIG. 6 shows a modification of the operating device, which provides a flow connection between the attachment pieces 19 and 21 with a valve 23.

When the sample quantity is held in the chamber 10, the same overpressure prevails at both ends of the channel region 7. Opening the valve 23 therefore does not lead to any displacement of the sample quantity. The pressure of the pressure sources may then be reduced simultaneously at both ends of the channel region 7 to atmospheric pressure and the flow cell may be decoupled without pressure from the operating device.

Advantageously, the sample quantity remains in place inside the chamber 10 in the decoupled flow cell, so that the flow cell does not have to remain in the operating apparatus for retention and performance of incubation processes between optical measurements, which is a great advantage particularly in the case of long incubation times.

As an alternative to the connecting line between the two pressure sources, the operating device may have two valves 24 and 25 which connect the respective pressure sources to the ambient atmosphere (FIG. 7), so that in this case as well the sample quantity positioned in the chamber 10 remains in the chamber 10 when the valves 24 and 25 takes place simultaneously with the same pressure reduction in the attachment spaces. The valves 24, 25 may be formed in different ways, for example as pneumatic valves. The valves may however also be mechanically switched valves as part of the flow cell, in which case membranes or septa of the flow cell, which can be pierced by cannulas of the operating device, may be envisioned. The controllable pressure source of the operating device may have a mechanical pump in conjunction with a pneumatic interface. A pump may also be configured as part of the flow cell, for example as a mechanical blister pump volume or according to the peristaltic principle.

A closed volume formed by the flow cell itself, or a separate chamber connectable to the flow cell, which does not form a component of an operating device, could also be envisioned as a passive pressure source.

In FIGS. 8a to 8e, which show the end portion 12, FIG. 8a relates to a film 26 that seals the opening 9 of the portion 12. This film 26, consisting of plastic or aluminum, may be applied by adhesive bonding or welding after introducing the reagent liquid or after the drying, in order to protect the reagent against environmental influences, in particular air humidity.

As an alternative thereto, the film 26 may serve to use the opening 9 during intended use of the flow cell in order to form a passive pressure source with the aid of the film.

FIG. 8b shows a porous membrane 27 that covers the opening 9, which transmits air but (up to a particular pressure) does not transmit liquid. Typical pore sizes lie in the range of 0.1-10 μm. Correspondingly, intended use of the flow cell may take place by using the membrane 27. Accidental escape of sample liquid through the opening 9 is advantageously avoided.

FIG. 8c shows an embodiment with a separate carrier 28 for a dry reagent. The injection-molded plastic carrier with a hydrophilized through-opening coated with dry reagent may be connected to the flow cell by adhesive bonding, welding or press fitting, the through-opening forming an end portion 12 of a channel region 7. Upon contact with the dry reagent, the sample liquid can flow over the region of the dry reagent beyond its end without emerging from the channel region, which promotes thorough mixing of the sample liquid with the reagent. Further, applying the dry substance onto the conveniently handleable carrier 28 is easier than direct application onto a projection on the base body of the flow cell.

FIG. 8d shows a separate carrier 28′, which is provided in the form of a plate having a plurality of through-holes for receiving a plurality of identical or different dry reagents. At least two of the through-holes that form end portions may have different diameters.

A separate carrier 28″, which is shown in FIG. 8e, differs from the carrier 28′ in that an overflow region 29 is formed and the opening 9 of the end portions 12 is correspondingly widened.

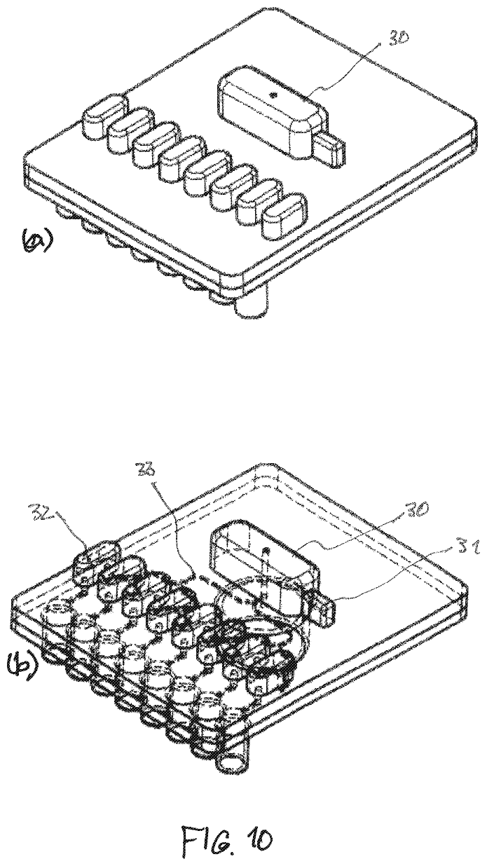

FIG. 9 shows a flow cell which differs from the flow cell described above in that a channel region 7 has a single entry portion 11 for receiving liquid to be processed and a plurality of end portions 12 with a dry reagent, parts of the channel region 7 respectively having at least one chamber, for example a detection chamber, for the analysis.

In the example shown, a defined sample liquid quantity is divided into eight fractions and delivered to eight end portions 12 with a dry reagent, in which case the dry reagents may differ from one end portion to another end portion. Thorough mixing and processing, or analysis, of the fractions take place separately from one another. The configuration of the end portions 12, or of the entry portion 11, may be carried out as in the exemplary embodiment above and, for example, hydrophilized in the manner described above.

In the example shown, chambers 10 that form analysis/detection regions have equal volumes.

The flow cell of FIG. 9 may be used like the flow cells described above. In order to place sample liquid after the analysis in the chambers in the state decoupled from an operating device, eight connecting lines and valves are required.

FIG. 10 shows a schematic representation of a manifold as part of an operating device which can be connected to the flow cell of FIG. 9 and has two welded plates, between which pneumatic channels that connect pressure sources are formed.

The plate that faces toward the flow cell has one attachment piece corresponding to the aforementioned attachment piece 19 and eight attachment pieces corresponding to the aforementioned attachment piece 21, which are connected to the flow cell in a hermetically leaktight fashion by means of a seal or O-rings. After connection, the flow cell and manifold form a closed pneumatic circuit.

The plate facing away from the flow cell has an active pressure source 30 including a pressure sensor, a pneumatic valve 31 for connecting the active pressure source to the environment, and eight pneumatic valves 32 which connect the active pressure source 30 to the eight passive pressure sources via pneumatic connecting channels 33 arranged between the plates, or disconnect them from one another. The passive pressure sources are formed from the sum of the volumes of the pneumatic channel regions between the closed valves 32 and the attachment pieces 21, the volume formed between the projections 21 of the manifold and the projections 2′ of the flow cell and the channel volume 7 of the flow cell between the sample liquid introduced and the end portion 12.

After connection of the flow cell to the manifold, a quantity of liquid introduced into the portion 11 of the flow cell of FIG. 9 is displaced in the direction of the end portions 12 by applying pressure by means of the active pressure source 30 with the valves 31 and 32 closed, as shown in FIG. 4, and is divided into eight substantially equally large fractions because of the eight substantially equally large passive pressure sources. After redissolving of the dry reagents and positioning of the reaction mixtures in the eight detection chambers 10, the disconnected active and passive pressure sources are at the same pressure level.

All the pressure sources are subsequently connected to one another by simultaneously opening the eight valves 32, without substantially altering the pressure level acting upstream and downstream on the liquid in the detection chamber. A preferably slow opening of the valve 31, the pressure level is reduced to ambient pressure in order to be able to separate the manifold from the flow cell without pressure, the eight liquid fractions remaining in the eight detection regions after the separation.

1-15. (canceled)

16. A microfluidic element for processing a quantity of liquid, comprising: a channel region; and a dry reagent arranged in an outwardly open end portion of the channel region so that the liquid comes in contact with the dry reagent.

17. The microfluidic element according to claim 16, wherein the microfluidic element is a flow cell.

18. The microfluidic element according to claim 16, wherein the channel region has a further outwardly open end portion that is in fluid communication with the end portion for introducing the quantity of liquid into the microfluidic element.

19. The microfluidic element according to claim 18, wherein the end portion and/or the further end portion are each bounded inward by a constriction of a cross-section of the channel.

20. The microfluidic element according to claim 19, wherein the constriction is permeable for air but impermeable for liquid at ambient pressure.

21. The microfluidic element according to claim 18, wherein the end portion and/or the further end portion of the channel region is a capillary channel.

22. The microfluidic element according to claim 21, wherein the capillary channel is hydrophobized.

23. The microfluidic element according to claim 18, further comprising a base body, wherein the end portion and/or the further end portion is formed in a projection that protrudes from the base body.

24. The microfluidic element according to claim 23, wherein the projection protrudes perpendicularly from the base body.

25. The microfluidic element according to claim 23, wherein the projection is formed integrally with a substrate that the base body comprises, or the end portion with the dry reagent is formed in a separate carrier element that at least partially forms the projection and is connected to the microfluidic element by adhesive bonding, welding and/or press fitting.

26. The microfluidic element according to claim 18, wherein the end portion is externally covered by a breakable film or a gas-permeable but liquid-impermeable membrane.

27. The microfluidic element according to claim 18, wherein the channel region has at least one chamber.

28. The microfluidic element according to claim 27, wherein the microfluidic element is at least partially transparent for optical measurements at least in a region of the chamber.

29. A method for producing a microfluidic element with an integrated dry reagent, comprising the steps of: arranging the dry reagent in an outwardly open end portion of a channel region; and forming the end portion from a projection that protrudes from a base body of the microfluidic element.

30. The microfluidic element according to claim 29, further including filling the end portion, which is configured as a capillary channel, from outside with a reagent liquid and subsequently drying with adhesion the dry reagent to a channel wall.

31. The microfluidic element according to claim 29, further including finally covering the end portion with a breakable film.

32. A combination, comprising: of a microfluidic element according to claim 18; and devices for operating the microfluidic element, the devices having a controllable pressure source for attachment to the further end portion that is intended to receive the quantity of liquid, and a passive pressure source comprising a closed compression space for attachment to the end portion that has the dry reagent.

33. The method for operating a microfluidic element according to claim 16 by operating devices, comprising the steps of: connecting a controllable pressure source to the further end portion of the channel region of the microfluidic element; connecting a passive pressure source to the end portion of the microfluidic element that contains the dry reagent; introducing a quantity of liquid into the further end portion; and displacing the quantity of liquid by the controllable pressure source against a rising pressure of the passive pressure source into the end portion that contains the dry reagent, in order to dissolve the dry reagent.

34. The method according to claim 33, including keeping the pressure of the controllable pressure source constant in order to hold the quantity of liquid, if appropriate with redissolved reagent, inside the channel region with a pressure equilibrium between the pressure sources in a desired position dependent on the constant pressure.

35. The method according to claim 34, including decoupling the microfluidic element from the operating devices by reducing the pressure of the pressure sources to atmospheric pressure while maintaining the pressure equilibrium, and positioning the quantity of liquid in a detection region after the redissolving of the dry reagent.
